(19) United States
(12) Patent Application Publication
(10) Pub. No.: US 2022/0164646 A1
(43) Pub. Date: May 26, 2022

(54) HYDRATABLE NEURAL NETWORKS FOR DEVICES

(71) Applicant: EMC IP Holding Company LLC, Hopkinton, MA (US)

(72) Inventor: Jaumir Valença da Silveira Junior, Rio de Janeiro (BR)

(21) Appl. No.: 17/102,769

(22) Filed: Nov. 24, 2020

(51) Int. Cl. G06N 3/08; G06N 3/04

(52) U.S. Cl. CPC G06N 3/08; G06N 3/04

(57) ABSTRACT

Hydratable neural networks are disclosed. A neural network can be trained in an adequate computing environment. The trained neural network is dehydrated into a hydration package. The hydration package is made portable. The hydration package can be extracted or imported into an end device such that the end device includes a personalized neural network.

### FIELD OF THE INVENTION

Embodiments of the present invention generally relate to neural networks. More particularly, at least some embodiments of the invention relate to systems, hardware, software, computer-readable media, and methods for hydratable and/or portable neural networks.

### BACKGROUND

Speech recognition often refers to the ability of a device to recognize the speech of a person. The ability of a device to accurately and consistently recognize speech for different users is less than perfect. Even when a device accurately recognizes the speech of a particular person, that same device may have trouble recognizing the speech of other users. Many devices that are voice-enabled struggle to recognize the speech of different persons. This problem is further complicated by the fact that many people speak with an accent and pronounce words differently and have different speech patterns.

In order to recognize speech, a device typically needs to have a speech or voice recognition engine (often implemented as a neural network). Some devices may use a remote neural network service, where the neural network is remote from the device. Other devices may have a neural network installed on the device itself. When the speech recognition engine or neural network resides on the device itself, several problems are presented.

First, training these types of speech recognition engines often requires more computational complexity that the device has. In other words, Internet of Things (IoT) devices and other devices may have the ability to recognize speech, but do not have the ability to train their speech recognition engines. As a result, users often become frustrated because these devices cannot consistently recognize their specific speech.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1A discloses aspects of a hydratable neural network;

FIG. 1B discloses aspects of a speech recognition framework;

FIG. 2 discloses aspects of a framework that includes devices with hydratable and personalized neural networks;

FIG. 3 discloses aspects of a device configured to implement a personalized neural network;

FIG. 4 discloses aspect of a method for personalizing a neural network; and

FIG. 5 discloses aspects of a method for running a personalized neural network on a device.

### DETAILED DESCRIPTION OF SOME EXAMPLE EMBODIMENTS

Embodiments of the present invention generally relate to neural networks. More particularly, at least some embodiments of the invention relate to systems, hardware, software, computer-readable media, and methods for automatic speech recognition (ASR) neural networks, also referred to herein as speech or voice recognition engines.

Although embodiments of the invention are described with respect to speech or voice recognition, embodiments of the invention are not so limited and may be applied to neural networks generally. Example embodiments of the invention relate to a framework of components that is configured to personalize neural network based automatic speech recognition systems. In particular, embodiments of the invention relates to personalizing the neural network speech recognition systems installed locally on various devices including, by way of example only, IoT devices, mobile devices, edge devices, or the like.

In one example, a neural network is personalized by training the neural network to better respond to or recognize the specific speech of a specific user. A neural network can be trained for any language and can be trained to account for the speech of the user (e.g., to account for the accent of the user, pronunciation of the user, speech patterns of the user, etc.). Embodiments of the invention further make the neural network mobile or portable such that the personalized neural network can be used with different devices.

In embodiments of the invention, this is accomplished using hydratable neural networks. In one example, hydration refers to the ability to extract features of a neural network (e.g., weights) into a package and then hydrate (i.e., load the neural network weights) a neural network using the package. This allows the training of the neural network to be separate and independent of the deployed neural network. Further, this relieves the end device of the need to train the neural network.

A user may train a neural network in, for example, the cloud, which has sufficient computing resources to train the neural network. The neural network can be dehydrated into a hydration package. In one example, this may include extracting the weights of the trained neural network into the hydration package, although the hydration package may contain the entire neural network in one example. The hydration package can then be used at any device. More specifically, the hydration package (e.g., the weights of the trained neural network stored in the hydration package) is imported into the device resident neural network. Once the device's neural network is hydrated, the device's neural network is personalized for that specific user.

Embodiments of the invention make the hydration package portable. This allows the user to personalize any neural network that is configured to accept the hydration package. Further, this allows the neural network of a device to be changed as needed. The user can retrain the neural network in the cloud and obtain an updated hydration package.

Although the neural network is personalized to the user, the device itself is not necessarily personalized to that user. The next user of the device can simply hydrate the neural network with their own hydration package in order to personalize the device's neural network. Thus, the device resident neural network can be hydrated/dehydrated as necessary and the speech recognition engine of the device can thus be personalized to many different users.

The framework allows a user to train a neural network in the cloud at their own pace using their own voice. The neural network in the cloud can be used for multiple users using a similar hydration process. Over time, the neural network improves as new data is added for training purposes. New hydration packages can be generated at any time from the neural network used for training. Further, a user may be able to generate hydration packages for different languages. For example, a user may train a first neural network for English and a second neural network for Spanish. This allows the user to have multiple hydration packages for multiple languages.

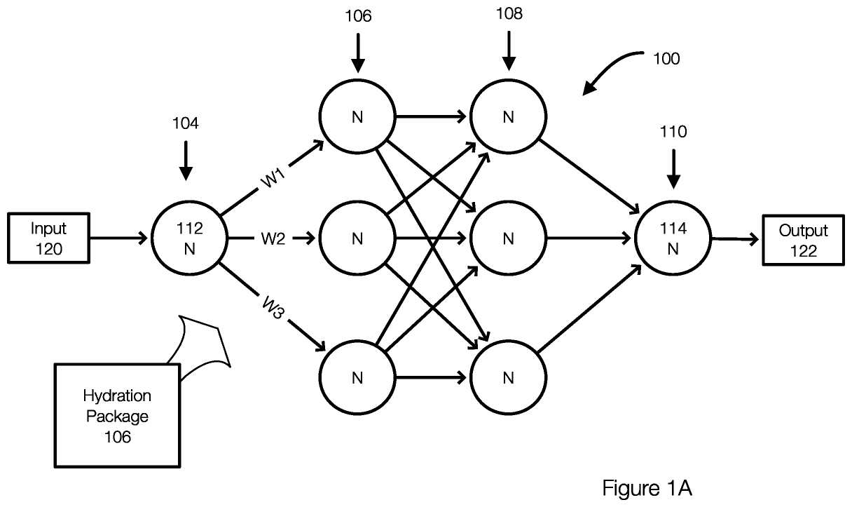

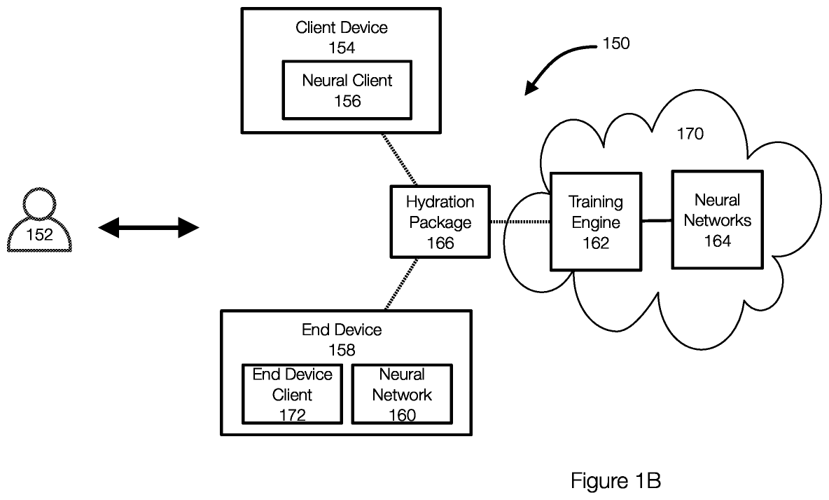

FIG. 1A illustrates an example of a hydratable neural network. The hydratable neural network 100 may include a plurality of nodes or neurons (each represented by N) that are arranged in layers. In this example, the neural network 100 includes an input layer 104, (hidden) layers 106 and 108 and an output layer 110.

An input 120 is received into an input neuron or node 112 and an output 122 is generated at the output neuron or node 114. The processing performed by the neural network 100 often relies on weights. Each connection between neurons or nodes is associated with a weight (represented by weights w1, w2, and w3 in FIG. 1A). All of the connections have a weight.

FIG. 1A further illustrates that the neural network 100 is configured to receive or import a hydration package 106. In one example, the weights of each connection are determined by or according to values stored in the hydration package 106. Thus, importing the hydration package 106 into the neural network 100 allows the weights of the connections in the neural network 100 to be set. Once this process is completed, the neural network 100 is prepared for use and is personalized to a specific user. When the neural network 100 is an automatic speech recognition neural network, the neural network 100 is prepared to recognize the speech of a particular user associated with the hydration package 106. In one example, the input 120 is speech and the output 122 is text corresponding to the input speech. The output could be a translation or other output.

FIG. 1B discloses aspects of a framework for personalized neural networks. FIG. 1B illustrates a framework 150 that may include various components or modules installed on different devices or computing environments. The framework 150 is typically configured to generate a hydration package 166 that can be used in an end device, which may be equipped with a hydratable neural network. The hydration package 166 can be consumed at or used by the end device to allow the device's neural network to perform, in this example, speech recognition, speech to text, or the like.

The framework 150 generally includes, in one example, a neural client 156, a hydratable neural network 160, and a training engine 162. In one example, the neural client 156 includes a user interface that may operate on a client device 154. The client device 154 may be a computing device (e.g., desktop computer, tablet device, mobile device, cloud-based device, server computer, or the like).

The neural client 156 is configured to interact with the training engine 162, which is typically based in a cloud environment or datacenter (e.g., cloud 170). The neural client 156 may send training requests to the training engine 162. The training engine 162 prepares hydration packages (e.g., the hydration package 166) and sends the hydration package 166 to the neural client 156.

The training engine 162 may operate on hardware sufficient to train multiple neural networks simultaneously or separately. The training engine 162 may be a cluster of servers for example, Based on training requests from the neural client 156, the training engine 162 uses the information or data in the training requests to train at least one of the neural networks 164. After training, the training engine 162 can generate a hydration package 166 from the trained neural network and deliver the hydration package 166 to the neural client 156. The training engine 162 could, in one example, direct the hydration package to the end device 158.

In effect, the training engine 162 may dehydrate the trained neural network by exporting weights of the trained neural network into the hydration package 162. The hydration package 166 is ultimately delivered to an end device client 172 operating on an end device 158. The end device client 172 may be configured to hydrate the neural network 160 resident on the end device 158 using the hydration package 166. Once the neural network 160 is hydrated with the weights (which were generated by training one of the neural networks 164 in the cloud independently of the end device 158), the end device 158 is ready to perform the relevant task for which the neural network 160 is prepared (e.g., speech recognition, speech to text, speech translation, or the like). Further, the neural network 160, once hydrated, is personalized to the user 152.

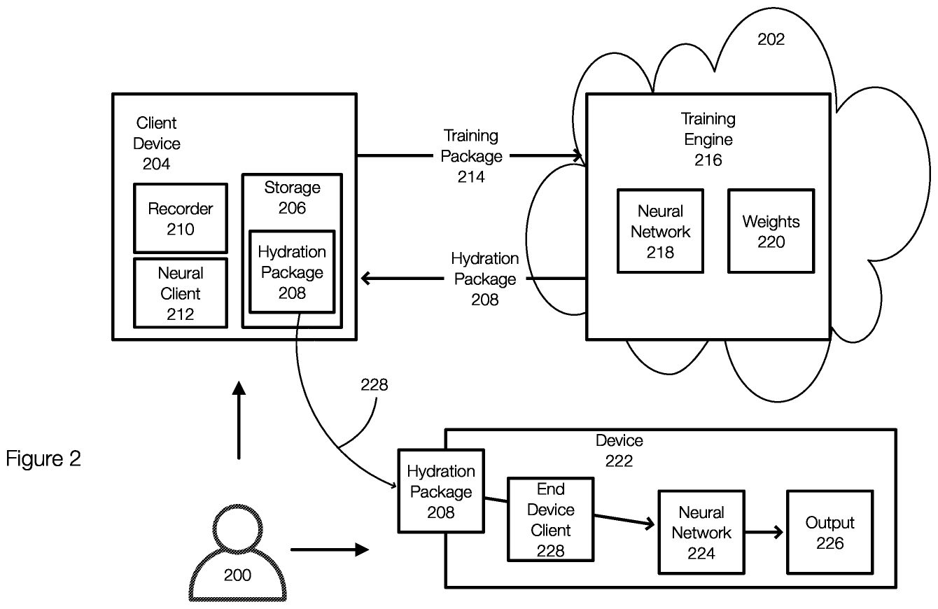

FIG. 2 discloses aspects of a framework for personalizing a neural network. FIG. 2 illustrates a user that may use a client device 204, such as a computing device, a desktop or laptop computer, tablet, or mobile device, or the like. The client device 204 may include a neural client 212, which includes a user interface.

Initially, the user 200 may register with the training engine 216, which may operate in a datacenter or cloud 202, through the neural client 212. The neural client 212 could also be implemented in the cloud and be accessible over a browser and/or integrated with the training engine 216. The training engine 216 may store or host multiple versions of a neural network 218. For example, a first version of the neural network 218 may be associated with English. Other versions are associated with other languages. Initially, the weights 220 of the neural networks are set at default values for a new user.

When the user 200 registers with the training engine 216, the user 200 may specify or identify a particular neural network. For example, the neural network (or version thereof) identified by the user 200 may be identified by neural network name, version, and language to be used with compliant devices, such as the device 222. By registering users such as the user 200, the training engine 216 can track the weights of the user 200 and other users over time. Thus, the weights 220 include weights for specific users, specific neural networks, or the like.

When the user 200 registers for the first time, a default hydration package 208 may be provided to the user 200. In one example, the initial or default hydration package 208 does not have the benefit of training with the user's voice data and may include default weights.

Once registered, the user 200 may begin the process of training the selected neural network. In this example, the client device 204 may include a recorder 210 that allows a recording of the user's voice to be performed. The recording can be performed with another device (e.g., on a smart phone) and uploaded to the user's account on the training engine 216. In one example, text of the voice recording is also provided for training purposes. The training package 214, which includes a voice recording (voice data) and text of the recording (text data) are then sent to the training engine 216. The training package 214 may include the voice data and the text data of the user. The training package 214 is used by the training engine 216 to train a neural network. Subsequent training packages 214 are used for training as well. This allows the user to train the neural network over time.

More specifically, for each user, the training engine 216 may store a history of training packages and may store a history of hydration packages. When a new training package is received from the client device 204, the training engine 216 may hydrate the relevant neural network with the user's most recent hydration package. Training is then performed using the new training package. When training is complete, a new or updated hydration package is generated, stored for future use, and transmitted to the client device 204 or, more specifically, to the neural client 212. The new hydration package may be available for download by the client device 204. The newest hydration package could also be distributed to various end devices at the direction of the user.

Because the training engine 216 can track the neural weights most recently used, and most recently generated, a user can train the neural network at his/her own pace and over time. A user, for example, may dictate or record a paragraph or two of voice data, generate the corresponding text data, and send the resultant training package when convenient. Over time, the neural network is improved. This allows the training engine 216 to train at the pace of the user based on the most recent weights. This also allows the same neural network to be trained for multiple users, by simply replacing the existing weights with the weights associated with the corresponding user.

When a new hydration package 208 is received from the training engine 216, the neural client 212 may prepare the hydration package 208 for use. For example, the hydration package 208 may be written or stored to a portable memory (e.g., a memory card, a USB drive, or the like). This allows the most recent hydration package 208 to be portable. In addition, the hydration package could be stored and transmitted wirelessly to an end device. The hydration package 208 may be delivered to any device associated with the user or to the device 222 using wired and/or wireless networks. For example, a user may store a hydration package on his/her mobile device and wirelessly deliver the hydration package to an end device. The hydration package may also be transmitted wirelessly by the client device 204 or using another network to an end device.

In one example, the neural client 212 (or the training engine 216) may prepare the hydration package 208 such that the entire neural network is also stored on the card or USB drive. This may be useful for an end device that does not have the neural network installed.

The user 200 is now prepared to use their hydration package 208. If stored on a card, the card can be inserted into the device 222 and the end device client 228 may install the hydration package 208. This may include extracting the weights into the neural network 224 (which may be the same as the training neural network) or installing the entire neural network 224. Once the neural network is hydrated or installed, the device 222 is thus ready to receive input from the user (e.g., voice) and output an output 226, such as text.

In one example, the device 222 may include a recorder to record the user's voice, generate a file and store the file at a pre-configured location. When a file is present in or detected at the pre-configured location, the neural network 224, using the hydrated neural network 224, may predict the text output 226 and store the output as a file in one example.

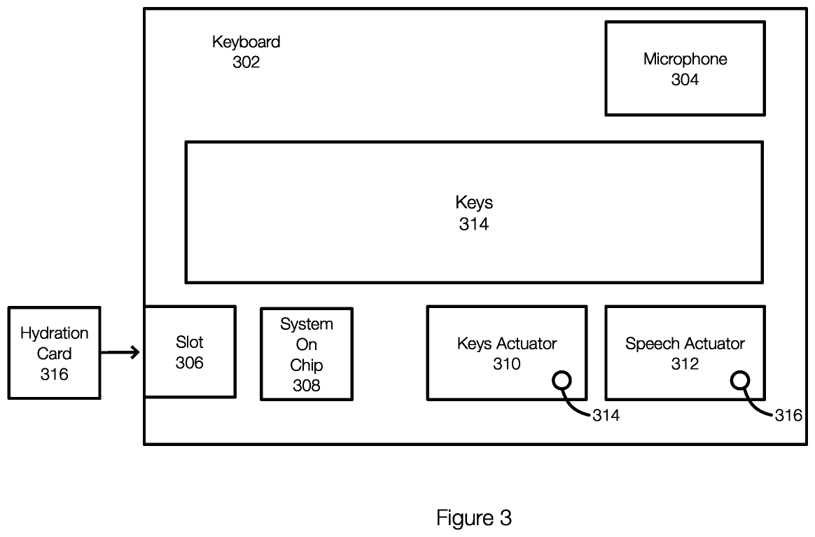

FIG. 3 illustrates an example of an end device that is configured to receive and implement a hydration package. FIG. 3 illustrates an example of a keyboard 302 that is configured with voice to text capabilities in accordance with embodiments of the invention. In this example, the keyboard 302 includes a microphone 304, a slot 306, a system on a chip (SoC) 308, a keys actuator 310 and a speech actuator 312. The slot 306 may also be a network device that allows the keyboard 302 to receive the hydration package wirelessly. In one example, the slot 206 or a card are examples of a hydration interface.

The SoC 308 may include a processor and memory in one example sufficient to run a neural network. The microphone 304 can receive a user's speech and generate a file. The keys actuator 310 (which may be a button and may be associated with a visual indicator 314 (e.g., an LED)) and the speech actuator 312 (which may be a button and may be associated with a visual indicator 316) allow the keyboard 302 to toggle between normal usage (keystrokes) and voice usage.

More specifically, the speech actuator 312 may be used to toggle the keyboard usage between a normal mode (keystrokes) and a voice mode. The visual indicator 316 is lit during voice mode. In voice mode, the microphone 304 is open for listening and the keyboard 302 is ready for the voice-to-text process. During the voice mode, the keyboard is configured to receive speech of a user and convert the speech to text using the hydrated neural network. In the normal mode, the keyboard may be placed in default operation—used as a keyboard where the user types.

The keys actuator 310 toggles the keyboard 302 between a normal voice mode and a key mode. In key mode, the user is not uttering normal text, but predefined keystroke combinations. For instance, if the user utters “Control Ey” the system will interpret the speech as the CTRL+A keyboard combination and send this keystroke combination to the keyboard output port. This is useful when you want to send text formatting characters exactly as you would via normal keyboard. The visual indicator 314 indicates that the key mode is activated. The keyboard may also be used as a conventional keyboard. More specifically, the keys actuator may operate when the voice mode of the speech actuator is active.

In one example, to save keyboard energy consumption, the slot 306 may be an active memory slot. When the hydration card 316 (which stores the weights and/or a full neural network) is inserted into the slot 306, the SoC 308 may receive power or may power on. Removing the card 316 may cut power to the SoC 308. Thus, the SoC 308, in one example, is only powered when the hydration card 316 is inserted into the slot 306.

For a device like the keyboard 302, in one embodiment, the memory card (the hydration card 316) may contain a full hydration package (the neural network and hydration package). In one example, the full hydration package may be a hydrated neural network. When the card 316 is inserted in the keyboard memory slot 306, it is immediately connected to the SoC 308. An auto install feature of the card 316 may be used to instantiate and start the neural network as well as to hydrate the neural network if necessary, making it ready for use.

The end user can then use the button set (the actuators 310 and 312) to activate the voice mode and start to talk to the keyboard 302 using the microphone 304. The neural network converts the voice input received through the microphone 304 to text. The SoC 308 may then send the keystroke combinations corresponding to the voice or the generated text to the keyboard output system. In other words, once the text is determined, the appropriate keyboard signals are generated and transmitted.

The keyboard output system may use standard output protocols to send keys to an attached computer or other device. From the perspective of the computer, the computer is receiving keyboard input or normal keystrokes.

Advantageously, embodiments of the invention can be operating system agnostic.

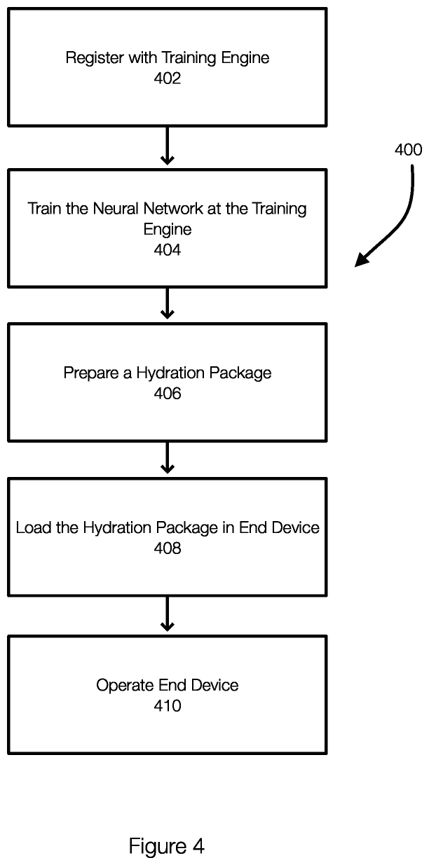

FIG. 4 discloses aspects of a method for personalizing neural networks. The method relates to aspects of training neural networks, deploying neural networks, loading neural networks, transporting neural networks, and the like. When personalizing a neural network, a user or a client device may register 402 with a training engine. Registering may only need to be performed the first time. When registering, the user may provide information regarding a user name, a neural network name or selection, a language, or the like. When registering, the user may be able to select the appropriate neural network via a user interface or identify a neural network based on desired language.

After the user is registered with the training engine, the selected neural network may be trained. The training engine may maintain metadata related to each user. The metadata may identify or associate the user name with a neural network, a neural network version, and a language. When the selected neural network is trained, the machine learning process may change or adapt weights in the neural network based on the training data included in the user's training packages. When training is completed, the weights of the trained neural network are extracted or saved into a hydration package. Whenever the user trains, the neural network is configured to its last known state. In other words, the hydration values may be saved and reloaded into the neural network when new training data is received.

Training 404 the neural network includes receiving a training package, which include voice data and text data. The voice data and the text data allows the neural network to be trained with the new data. Over time, the accuracy and reliability of the neural network improve. With each training package, a new hydration package may be prepared 406 and delivered to the user.

When the user (or the user's device) receives the hydration package, the hydration package may be used to hydrate the neural networks of end devices. If the end device already has the neural network (typically the same name and version of the one trained in the cloud), the hydration package is used to hydrate 408 the neural network. In one example, the entire neural network may be included in the hydration package and may be loaded on the end device.

Once the hydration package is loaded, the end device is operated 410. Thus, voice may be received as input and the loaded or hydrated neural network may output text or provide an output based on the function of the neural network. As previously described, the neural network may be used to convert voice to text for use in a keyboard. The speech is converted, in effect, into keystrokes. In another example, the speech may be translated into another language.

In one example, each user may have a card configured to store a hydration package or may have a hydration package that can be delivered to the end device. This allows each user to use their card at a properly configured end device such that the neural network can be configured for that user specifically. Replacing the card with the card of another user personalizes the neural network to that user. Further, these cards can be used with a wide variety of different devices. When the hydration package is delivered wirelessly, the end device may be configured to receive the hydration package and dehydrate/hydrate the neural network as needed.

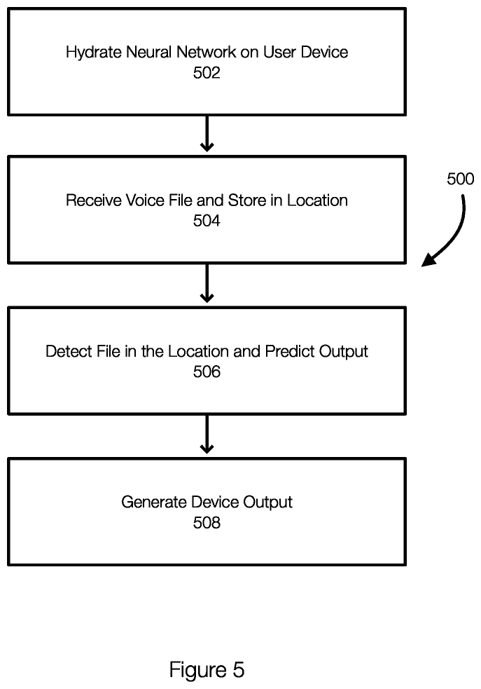

FIG. 5 discloses aspects of using a personalized neural network with a device. The method 500 may begin by hydrating 502 a neural network on a device such as an end device, an edge device, a sensor, or the like. Hydrating 502 the device may include inserting a card (or wirelessly delivering a hydration package) having a neural network or portion thereof stored thereon and instantiating the neural network on the device or extracting the weights stored in a hydration package on the device into the neural network already present on the device.

Once the neural network is hydrated, the device may begin operation. In one example, a voice file is received 504 (e.g., by recording the voice and generating the voice file) and stored in a predetermined location on the device (e.g., in a predetermined directory). The voice file may be generated using a microphone on the device. In one example, a new voice file is generated when the user pauses for a predetermined time.

When a new file is detected 506 at the location, the file is input to the neural network and a prediction or output is generated 506. For example, a keyboard may receive voice data as input and output a plurality of keystrokes or keystroke data. The device uses the text output by the neural network to output 508 keystrokes, for example, to a computer or other device attached to the keyboard.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth herein. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In general, embodiments of the invention may be implemented in connection with systems, software, and components, that individually and/or collectively implement, and/or cause the implementation of, neural network and related operations. More generally, the scope of the invention embraces any operating environment in which the disclosed concepts may be useful.

Example cloud computing environments (e.g., the cloud, a datacenter), which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, or virtual machines (VM)

Particularly, devices in the operating environment may take the form of software, physical machines, or VMs, or any combination of these, though no particular device implementation or configuration is required for any embodiment.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

It is noted with respect to the example methods discussed herein that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted.

Following are some further example embodiments of the invention. These are presented only by way of example and are not intended to limit the scope of the invention in any way.

Embodiment 1. A method, comprising: receiving a training package from a client device at a training engine, the training package including user generated data, training a neural network with the training package, preparing a hydration package from the trained neural network, wherein the hydration package includes weights extracted from the trained neural network, and delivering the hydration package to the client device.

Embodiment 2. The method of embodiment 1, wherein the user generated data include voice data and text data corresponding to the voice data, further comprising recording the voice data.

Embodiment 3. The method of embodiment 1 and/or 2, further comprising registering a user with the training engine and selecting the neural network to be trained.

Embodiment 4. The method of embodiment 1, 2 and/or 3, further comprising storing weights of the neural network after training with the training package and, when receiving a second training package, loading the stored weights into the neural network and training with the second training package to generate new weights.

Embodiment 5. The method of embodiment 1, 2, 3, and/or 4, further comprising generating a new hydration package based on the new weights and delivering the new hydration package to the client device.

Embodiment 6. The method of embodiment 1, 2, 3, 4, and/or 5, further comprising loading the hydration package on a portable device.

Embodiment 7. The method of embodiment 1, 2, 3, 4, 5, and/or 6, further comprising connecting the portable device to an end device.

Embodiment 8. The method of embodiment 1, 2, 3, 4, 5, 6, and/or 7, further comprising extracting, at the end device, the hydration package into a neural network resident on the end device.

Embodiment 9. The method of embodiment 1, 2, 3, 4, 5, 6, 7, and/or 8, further comprising operating the end device in a voice mode such that the hydrated neural network converts speech of a user into an output.

Embodiment 10. The method of embodiment 1, 2, 3, 4, 5, 6, 7, 8, and/or 9, wherein the hydration package includes a hydrated neural network.

Embodiment 11. A method for performing any of the operations, methods, or processes, or any portion of any of these, disclosed herein.

Embodiment 12. A non-transitory storage medium having stored therein instructions that are executable by one or more hardware processors to perform operations comprising the operations of any one or more of or portions thereof of embodiments 1-12.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

Any one or more of the entities disclosed, or implied, by the Figures and/or elsewhere herein, may take the form of, or include, or be implemented on, or hosted by, a physical computing device. As well, where any of the aforementioned elements comprise or consist of a virtual machine (VM), that VM may constitute a virtualization of any combination of the physical components disclosed herein.

In one example, the physical computing device includes a memory which may include one, some, or all, of random access memory (RAM), non-volatile memory (NVM) such as NVRAM for example, read-only memory (ROM), and persistent memory, one or more hardware processors, non-transitory storage media, UI device, and data storage. One or more of the memory components of the physical computing device may take the form of solid state device (SSD) storage. As well, one or more applications may be provided that comprise instructions executable by one or more hardware processors to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving a training package from a client device at a training engine, the training package including user generated data;
training a neural network with the training package;
preparing a hydration package from the trained neural network, wherein the hydration package includes weights extracted from the trained neural network; and
delivering the hydration package to the client device.

2. The method of claim 1, wherein the user generated data include voice data and text data corresponding to the voice data, further comprising recording the voice data.

3. The method of claim 1, further comprising registering a user with the training engine and selecting the neural network to be trained.

4. The method of claim 1, further comprising storing weights of the neural network after training with the training package and, when receiving a second training package, loading the stored weights into the neural network and training with the second training package to generate new weights.

5. The method of claim 4, further comprising generating a new hydration package based on the new weights and delivering the new hydration package to the client device.

6. The method of claim 1, further comprising loading the hydration package on a portable device.

7. The method of claim 6, further comprising connecting the portable device to an end device.

8. The method of claim 7, further comprising extracting, at the end device, the hydration package into a neural network resident on the end device.

9. The method of claim 8, further comprising operating the end device in a voice mode such that the hydrated neural network converts speech of a user into an output.

10. The method of claim 1, wherein the hydration package includes a hydrated neural network.

11. A non-transitory storage medium having stored therein instructions that are executable by one or more hardware processors to perform operations comprising:
receiving a training package from a client device at a training engine, the training package including user generated data;
training a neural network with the training package;
preparing a hydration package from the trained neural network, wherein the hydration package includes weights extracted from the trained neural network; and
delivering the hydration package to the client device.

12. The non-transitory storage medium of claim 11, wherein the user generated data include voice data and text data corresponding to the voice data, further comprising recording the voice data.

13. The non-transitory storage medium of claim 11, further comprising registering a user with the training engine and selecting the neural network to be trained.

14. The non-transitory storage medium of claim 11, further comprising storing weights of the neural network after training with the training package and, when receiving a second training package, loading the stored weights into the neural network and training with the second training package to generate new weights and generating a new hydration package based on the new weights and delivering the new hydration package to the client device.

15. The non-transitory storage medium of claim 11, further comprising loading the hydration package on a portable device, connecting the portable device to an end device, and extracting, at the end device, the hydration package into a neural network resident on the end device.

16. The non-transitory storage medium of claim 15, further comprising operating the end device in a voice mode such that the hydrated neural network converts speech of a user into an output.

17. The non-transitory storage medium of claim 11, wherein the hydration package includes a hydrated neural network.

18. A device comprising:
a neural network configured to be hydrated with a hydration package;
a hydration interface configured to receive the hydration package, the hydration package including at least weights for a neural network;
a microphone;
a processor and a memory;
a speech actuator configured to place the device in a normal mode or a voice mode, wherein the voice mode causes the device to receive speech of a user and wherein the normal mode cases a default operation of the device; and
a key actuator configured to place the device in a normal voice mode where the speech of the user is converted by the neural engine or a key mode where the speech of the user is converted to commands; and
wherein the neural network, when the speech actuator is in voice mode, converts the speech of the user into an output.

19. The device of claim 18, wherein the hydration interface is a port configured to receive a card or a network card configured to wirelessly receive the hydration package, wherein the device is a keyboard and the output is keystrokes that are output via a keyboard output port to a computing device when in the voice mode and in the normal voice mode and wherein the output is a keystroke command that is output via the keyboard output port when in the voice mode and the key mode.

20. The device of claim 18, wherein the processor and memory are configured to convert the speech of the user to a file and store the file at a predetermined location, wherein the file is provided as input to the neural network.
